(19) United States
(12) Patent Application Publication
(10) Pub. No.: US 2012/0037762 A1
(43) Pub. Date: Feb. 16, 2012

(54) CABLE RETAINING BRACKET AND FAN USING SAME

(76) Inventor: Bill Wu, Sinjhuang City (TW)

(21) Appl. No.: 12/855,931

(22) Filed: Aug. 13, 2010

(51) Int. Cl. F16L 3/08

(52) U.S. Cl. 248/65

(57) ABSTRACT

A cable retaining bracket and a fan using the same are disclosed. The cable retaining bracket can be assembled to a frame, and includes a main body having a first, a second, a third, and a fourth end; a first and a second retaining arm extended from the first and the third end, respectively; and a first shoulder portion being extended from one of the second and the fourth end of the main body. The fan includes a frame and the cable retaining bracket. The frame is provided with a cable slot for receiving a set of cables therein. The cable retaining bracket can be conveniently assembled to the frame for holding the set of cables flatly and orderly in the cable slot with the first shoulder portion located on the cable slot to hold down the set of cables and guide the same toward the frame.

### FIELD OF THE INVENTION

The present invention relates to a cable retaining bracket, and more particularly to a cable retaining bracket that can be conveniently assembled to a fan frame to hold down a set of cables in a cable slot on the frame. The present invention also relates to a fan using the cable retaining bracket.

### BACKGROUND OF THE INVENTION

Currently, with the constant progress in technological fields, people rely more and more on various kinds of electronic devices in their daily life. Electronic elements in the electronic devices, such as computers and notebook computers, will produce a large amount of heat during operation thereof. The produced heat must be timely removed from the electronic devices to avoid the problem of overheat.

For example, in a computer, the heat-producing elements thereof include the central processing unit (CPU), the power supply, etc. When the computer works, the CPU operates at high speed to produce high temperature, which will dangerously bring the CPU to an unstable state, resulting in shutdown or even damage and burnout of the computer. To solve this problem, one of the generally measures being taken is to provide at least one cooling fan in the computer. With the cooling fan, or briefly referred to as a fan, the heat produced by the CPU is forced out of the computer to ambient air.

Please refer to FIG. 1A, in which a conventional fan 10 is shown. The fan 10 includes a frame 20 and a blade assembly 30. The frame 20 has an air-in side 21 and an opposite air-out side 22. The blade assembly 30 is fixedly connected to the air-out side 22. A plurality of blades (not shown) is oriented toward the air-in side 21. The frame 20 is provided at a predetermined position with a sunken cable slot 23, a first receiving slot 24 and a second receiving slot 25. The cable slot 23 has a first opening 231 and a second opening 232 corresponding to an inner and an outer side of the frame 20. A cable-guiding slot 233 is further provided at the second opening 232. The first and the second receiving slot 24, 25 are separately located at two opposite lateral sides of the cable slot 23, and are respectively internally provided with a first and a second retaining hole 241, 251. A set of cables 26 electrically connected to the fan 10 is held in the cable slot 23.

As can be seen from FIGS. 1A and 1B, after the set of cables 26 is extended through the first opening 231 and the second opening 232 to set in the cable slot 23, a cable retaining bracket 40 must be correspondingly assembled to the cable slot 23 to locate on the set of cables 26. The cable retaining bracket 40 has two retaining arms 41 separately downward extended from two opposite ends of the bracket 40 for inserting into the first and the second receiving slot 24, 25, such that the retaining arms 41 are stopped by the first and second retaining holes 241, 251 from moving out of the first and second receiving slots 24, 25. In this manner, the set of cables 26 is held in the cable slot 23 and is further guided by the cable-guiding slot 233 at the second opening 232 to extend toward and be received in the frame 20.

However, after the set of cables 26 is held in the cable slot 23 by the cable retaining bracket 40, there are still portions of the cables 26 exposed to external environment at the first and the second opening 231, 232 without being orderly and flatly located at the first and second openings 231, 232. That is, the set of cables 26 tends to disorderly protrude beyond the cable slot 23 and the frame 20 at the first and second openings 231, 232 to cause undesirable pulling of the cables 26 against the frame 20. To overcome this problem, an additional mounting procedure is needed to guide the cables 26 through the second opening 232 into the frame 20. It is noted the conventional cable retaining bracket 40 is generally in a reverse-U shape corresponding to the cable slot 23 and has a relatively small contact area, which prevents a user from easily applying a force to the bracket 40 for assembling the latter to the cable slot 23. In other words, the conventional cable retaining bracket 40 requires more time and energy to be assembled to the frame 20.

In conclusion, the conventional cable retaining bracket for a cooling fan has the following disadvantages: (1) the set of cables of the fan tends to protrude beyond the frame and expose to the ambient environment; (2) the exposed and protruded set of cables is subject to undesirable pull against the frame; (3) the cable retaining bracket does not allow convenient application of force thereto; and (4) it takes more time and energy to assemble the cable retaining bracket to the cable slot on the fan frame.

It is therefore tried by the inventor to develop an improved cable retaining bracket for cooling fan and a cooling fan for using with such improved cable retaining bracket.

### SUMMARY OF THE INVENTION

A primary object of the present invention is to provide a cable retaining bracket that includes an extended shoulder portion to hold down a set of cables orderly against a frame, so as to effectively prevent the cables from disorderly protruding beyond the frame.

Another object of the present invention is to provide a cable retaining bracket to avoid a set of cables from being undesirably pulled against a frame.

A further object of the present invention is to provide a cable retaining bracket that can be conveniently assembled to a frame with reduced energy and time for orderly holding down a set of cables against the frame.

To achieve the above and other objects, the cable retaining bracket according to the present invention can be assembled to a frame for holding at least one cable in place against the frame. The cable retaining bracket includes a main body having a pair of opposite first and third end and a pair of opposite second and fourth end; a first and a second retaining arm respectively extended from the first and the third end of the main body; and a first shoulder portion extended from one of the second and the fourth end.

Also, to achieve the above and other objects, the present invention provides a fan using the above-described cable retaining bracket. The fan includes a frame and the cable retaining bracket. The frame is formed with a cable slot, a first receiving slot, and a second receiving slot. The cable slot is extended through the first and second receiving slots. The first and the second receiving slot are respectively internally provided with a first and a second retaining hole. The cable slot is adapted to receive a set of cables, which is electrically connected to a circuit board of the fan. The cable retaining bracket includes a main body having a pair of opposite first and third end and a pair of opposite second and fourth end; a first and a second retaining arm respectively extended from the first and the third end of the main body; and a first shoulder portion extended from one of the second and the fourth end. The first and the second retaining arm are correspondingly inserted into the first and the second receiving slot; and the first shoulder portion is correspondingly fitted in the cable slot. With the above arrangements, the cable retaining bracket can be conveniently assembled to the fan frame at reduced energy and time, and it is able to effectively prevent the set of cables from disorderly protruding beyond the frame by the cable retaining bracket. Thus, the cable retaining bracket of the present invention provides the following advantages: (1) it effectively prevents cables from disorderly protruding beyond the fan frame; (2) it prevents the cables from being undesirably pulled against the fan frame; (3) it allows an operator to conveniently apply a force thereto for assembling it to the fan frame; and (4) it can be assembled to the fan frame with reduced energy and time.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1A is an assembled perspective view of a conventional fan;

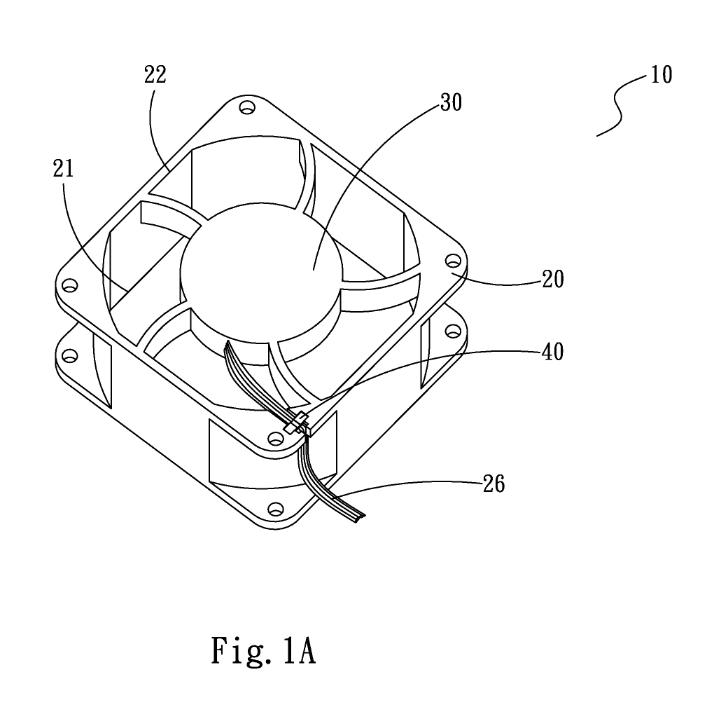

FIG. 1B is a fragmentary, enlarged and partially exploded perspective view of FIG. 1A;

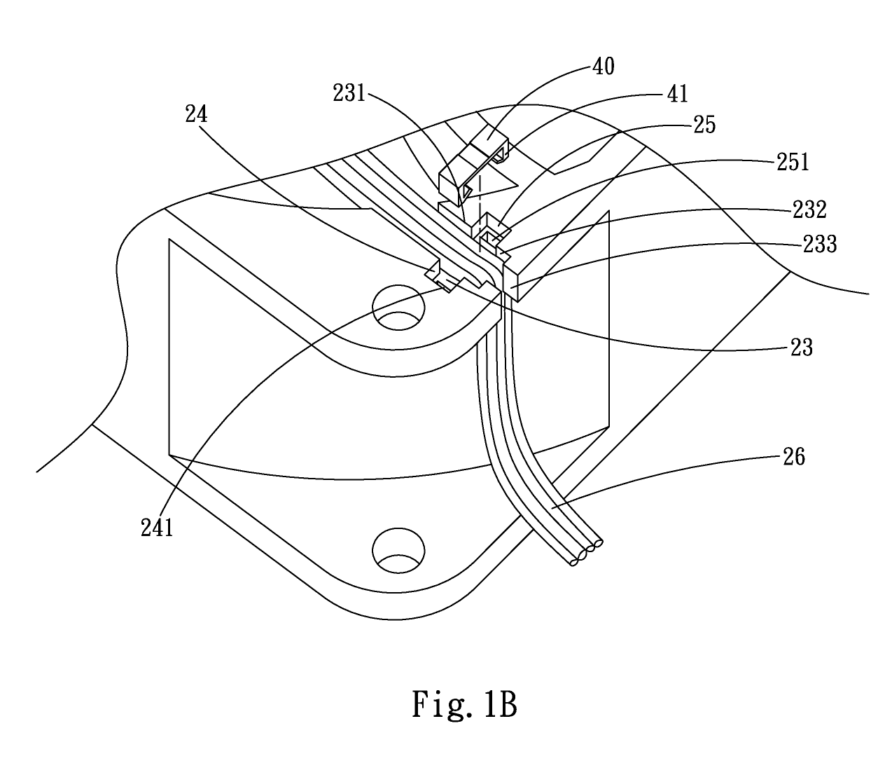

FIG. 2A is a perspective view of a cable retaining bracket according to a first embodiment of the present invention;

FIG. 2B is an assembled perspective view of a fan with the cable retaining bracket according to the first embodiment of the present invention;

FIG. 2C is a fragmentary, enlarged and partially exploded perspective view of FIG. 2B;

FIG. 3A is a perspective view of a cable retaining bracket according to a second embodiment of the present invention;

FIG. 3B is an assembled perspective view of a fan with the cable retaining bracket according to the second embodiment of the present invention;

FIG. 3C is a fragmentary, enlarged and partially exploded perspective view of FIG. 3B;

FIG. 4A is a perspective view of a cable retaining bracket according to a third embodiment of the present invention;

FIG. 4B is an assembled perspective view of a fan with the cable retaining bracket according to the third embodiment of the present invention;

FIG. 4C is a fragmentary, enlarged and partially exploded perspective view of FIG. 4B;

FIGS. 5A, 5B and 5C show that a holding-down element can be provided on the cable retaining bracket according to the present invention at different positions;

FIGS. 6A, 6b and 6C show a different configuration of the holding-down element for the cable retaining bracket of the present invention;

FIG. 7A is an assembled perspective view showing the cable retaining bracket according to the first embodiment of the present invention being used on a fan with another type of frame;

FIG. 7B is a fragmentary, enlarged and partially exploded perspective view of FIG. 7A;

FIG. 7C is an assembled perspective view showing the cable retaining bracket according to the third embodiment of the present invention being used on a fan with another type of frame;

FIG. 7D is a fragmentary, enlarged and partially exploded perspective view of FIG. 7C.

### DETAILED DESCRIPTION OF THE PREFERRED EMBODIMENTS

The present invention will now be described with some preferred embodiments thereof by referring to the accompanying drawings. For the purpose of easy to understand, elements that are the same in the preferred embodiments are denoted by the same reference numerals.

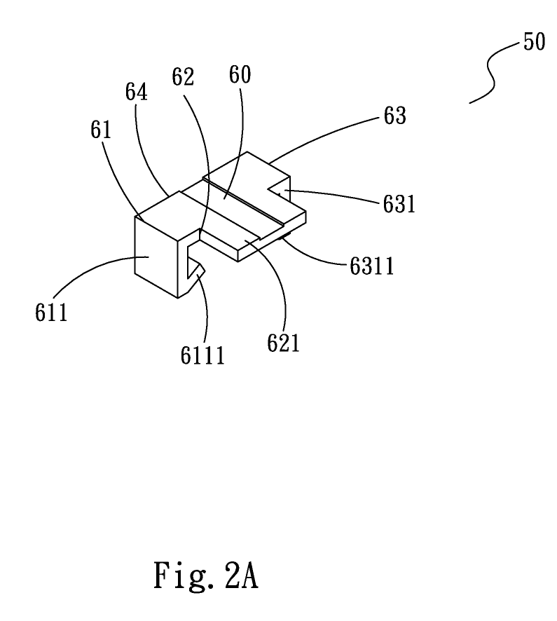

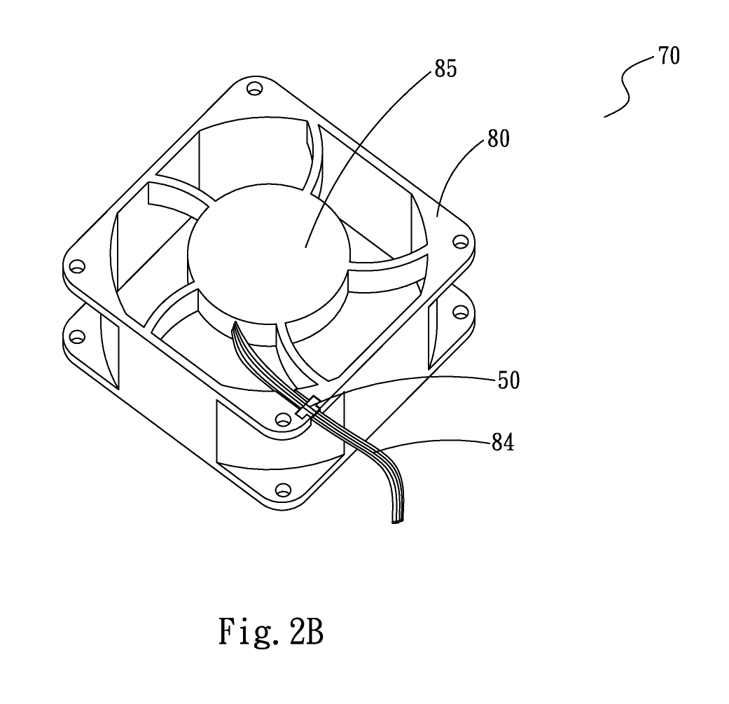

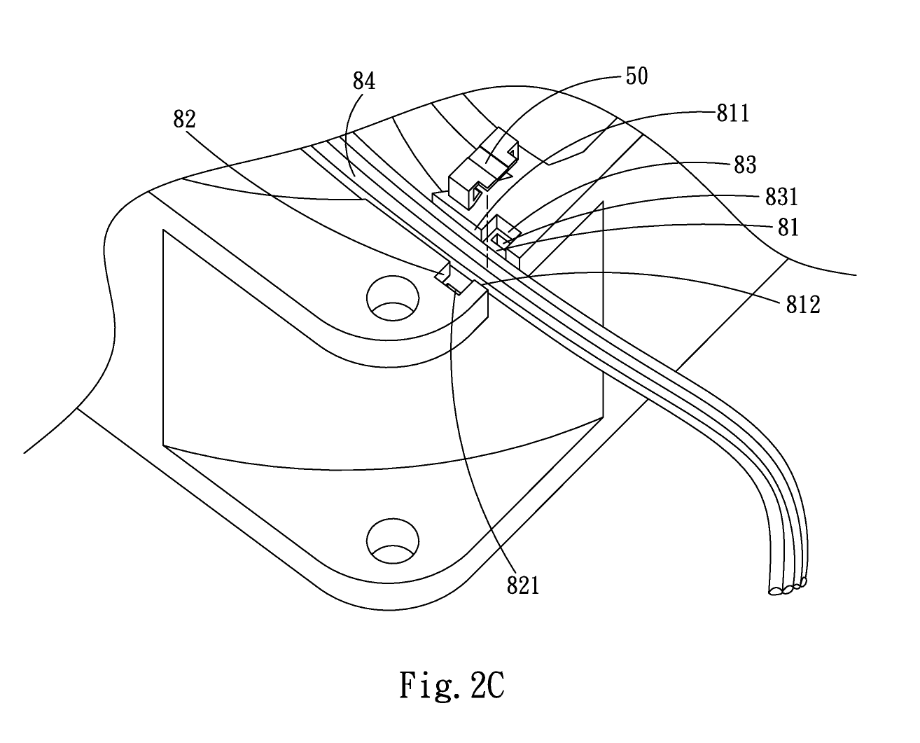

Please refer to FIG. 2A that is a perspective view of a cable retaining bracket 50 according to a first embodiment of the present invention. As shown, the cable retaining bracket 50 in the first embodiment includes a main body 60 having a first end 61, a second end 62, a third end 63, and a fourth end 64. The first end 61 and the third end 63 are extended from the main body 60 to form a first retaining arm 611 and a second retaining arm 631, respectively. The first and the second retaining arm 611, 631 are formed at respective one end distal from the main body 60 with a first hook 6111 and a second hook 6311. One of the second and the fourth end 62, 64 is extended from the main body 60 to form a first shoulder portion. In the illustrated first embodiment, it is the second end 62 that extends from the main body 60 to form the first shoulder portion 621.

Please refer to FIGS. 2A, 2B and 2C. In FIG. 2B, there is shown a fan 70 with the cable retaining bracket 50 according to the first embodiment thereof. FIG. 2C is a fragmentary, enlarged and partially exploded perspective view of FIG. 2B. As shown, the fan 70 includes a frame 80, a set of cables 84, and the cable retaining bracket 50. The frame 80 is provided on one edge with a cable slot 81, a first receiving slot 82, and a second receiving slot 83. The cable slot 81 has a first opening 811 and a second opening 812 respectively corresponding to an inner and an outer side of the frame 80. The first receiving slot 82 and the second receiving slot 83 are separately located at two opposite lateral sides of the cable slot 81, and are respectively internally provided with a first retaining hole 821 and a second retaining hole 831. The fan 70 has a central base 85 formed at a center of the frame 80, and a fan circuit board (not shown) is mounted in the central base 85 to electrically connect to the set of cables 84. The set of cables 84 is extended from the central base 85 through the first opening 811, the cable slot 81 and the second opening 812 to the outer side of the frame 80.

The cable retaining bracket 50 is assembled to the cable slot 81 to locate on the set of cables 84. More specifically, the main body 60 of the cable retaining bracket 50 is covered onto the set of cables 84 to hold down the latter while the first retaining arm 611 at the first end 61 and the second retaining arm 631 at the third end 63 of the main body 60 are downward inserted into the first receiving slot 82 and the second receiving slot 83, respectively, with the first hook 6111 and the second hook 6311 being respectively extended through and stopped by the first and the second retaining hole 821, 831 from moving out of the first and the second receiving slot 82, 83. At this point, the first shoulder portion 621 at the second end 62 is correspondingly located at the second opening 812, bringing the set of cables 84 to flatly and orderly lie in the cable slot 81 without disorderly protruding beyond the frame 80. Further, the main body 60 and the first shoulder portion 621 together form a relatively large contact area, at where an operator can conveniently apply a force to easily assemble the cable retaining bracket 50 to the frame 80 with reduced energy and time.

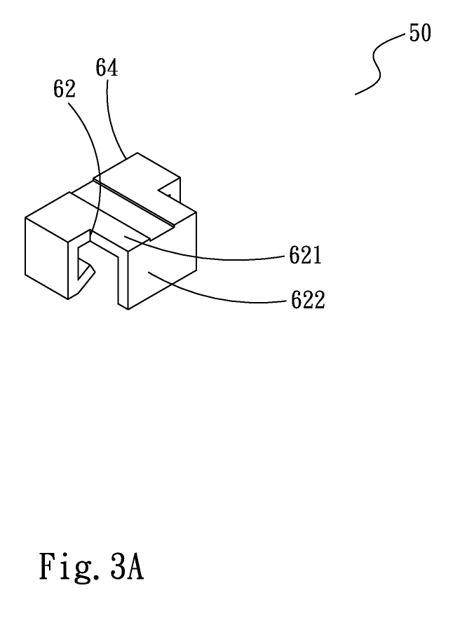

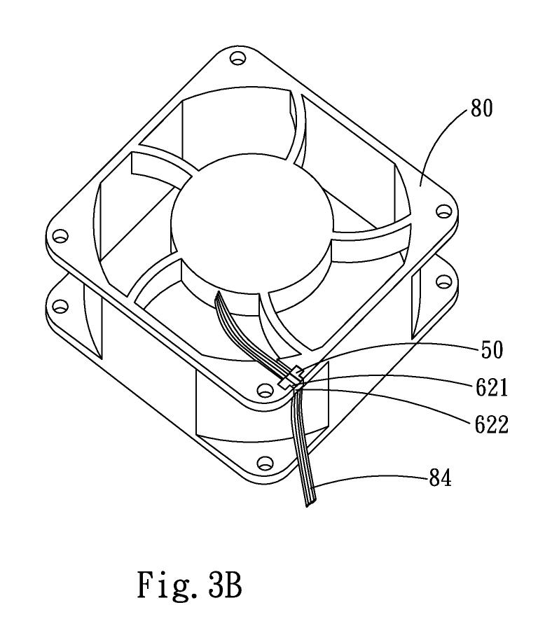

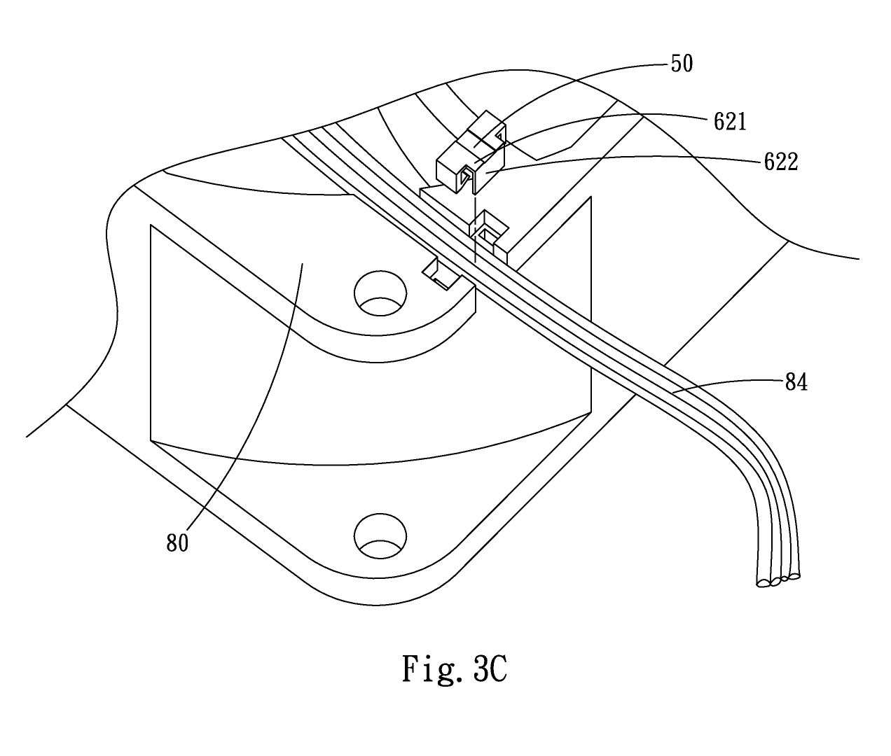

FIGS. 3A, 3B and 3C illustrate a cable retaining bracket 50 according to a second embodiment of the present invention and the use of it on the fan frame 80. The cable retaining bracket 50 in the second embodiment has elements, connecting manner and functions generally similar to the first embodiment, therefore, the elements that are the same in the two embodiments are not repeatedly described herein. The second embodiment is different from the first embodiment in that an end of the first shoulder portion 621 corresponding to the outer side of the frame 80 is downward extended to form at least one projected portion 622. When the first shoulder portion 62 holds down the set of cables 84 to a flat and orderly state in the cable slot 81, the projected portion 622 guides the set of cables 84 toward the frame 80, so that the set of cables 84 can be orderly received in the frame 80 without additional energy and time. This further enables convenient assembly of the cable retaining bracket 50 to the cable slot 81 at reduced energy and time and prevents the set of cables 84 from being undesirably pulled against the frame 80.

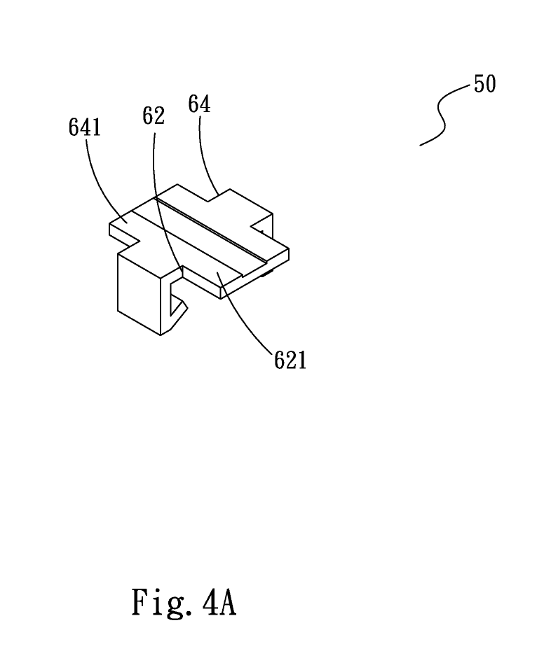

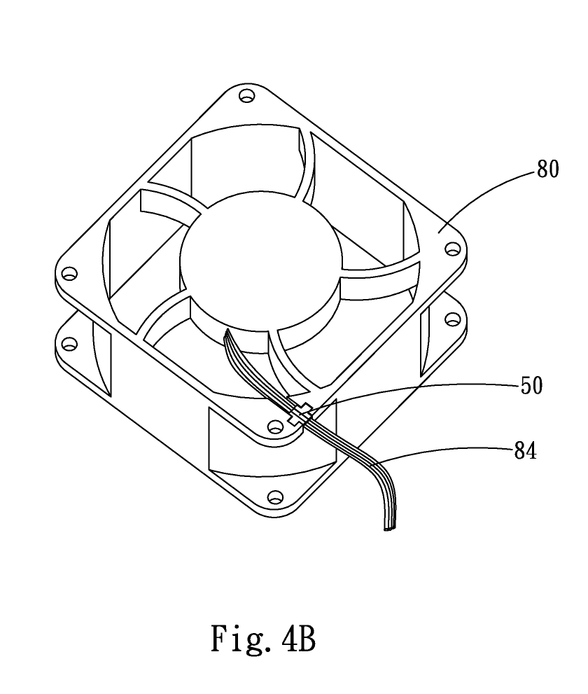

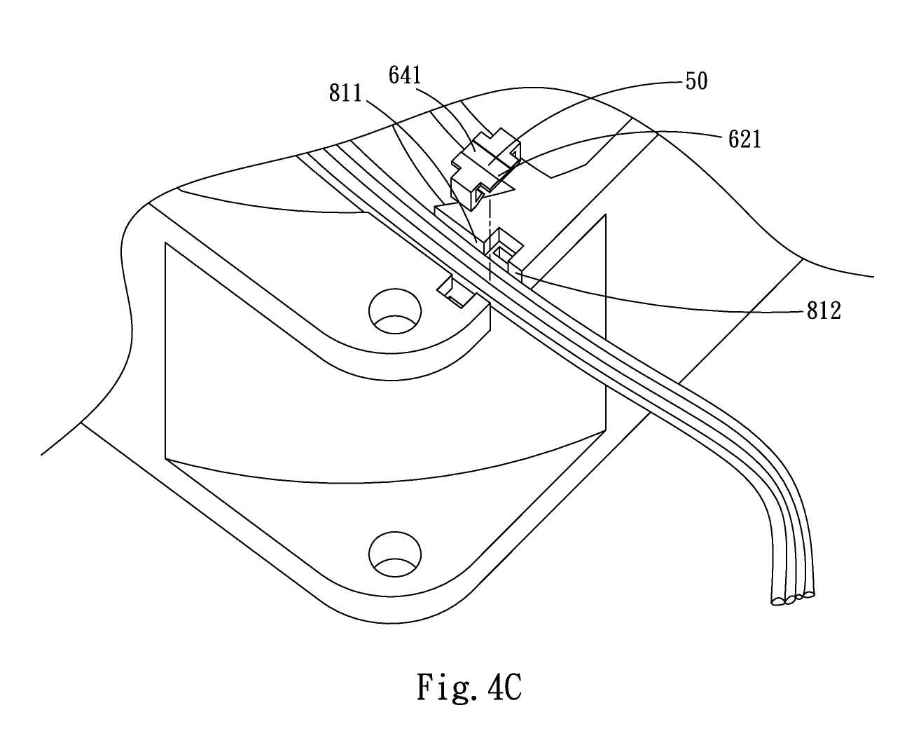

FIGS. 4A, 4B and 4C illustrate a cable retaining bracket 50 according to a third embodiment of the present invention and the use of it on the fan frame 80. As shown, the cable retaining bracket 50 in the third embodiment has a first shoulder portion 621 and a second shoulder portion 641 extended from the second end 62 and the fourth end 64 of the main body 60, respectively. When the cable retaining bracket 50 is assembled to the frame 80, the first and the second shoulder portion 621, 641 are correspondingly located on the first opening 811 and the second opening 812, respectively, to hold down the set of cables 84 at the first and the second opening 811, 812. The first and second shoulder portions 621, 641 and the main body 60 together provide an increased contact area, at where an operator can easily apply a force to assemble the cable retaining bracket 50 to the frame 80.

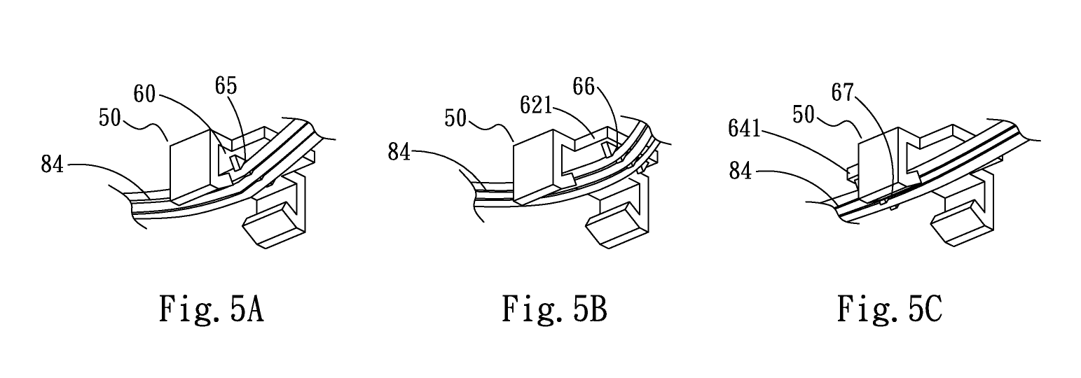

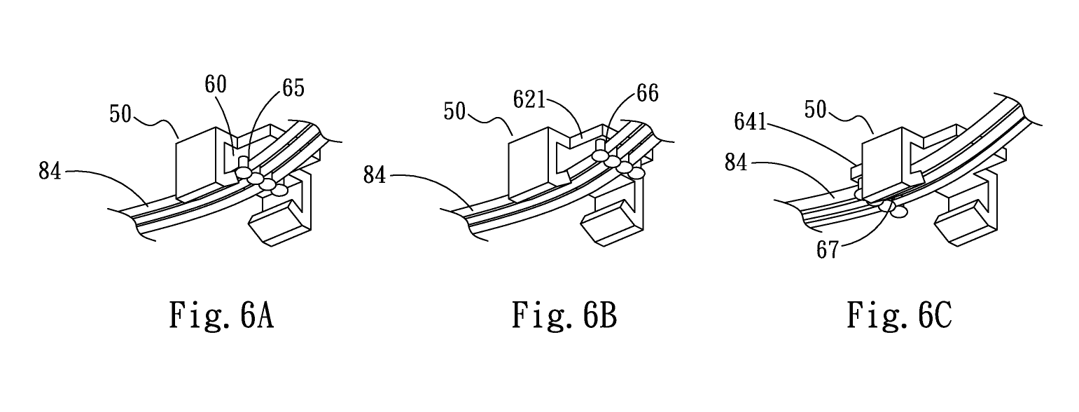

Please refer to FIGS. 5A to 5C. The cable retaining bracket 50 can be provided on the main body 60 at one side facing toward the frame 80 with at least one first holding-down element 65 (see FIG. 5A), or on the first shoulder portion 621 at one side facing toward the frame 80 with at least one second holding-down element 66 (see FIG. 5B), or on the second shoulder portion 641 at one side facing toward the frame 80 with at least one third holding-down element 67 (see FIG. 5C), such that when the cable retaining bracket 50 is assembled to the cable slot 81 to locate on the set of cables 84, the set of cables 84 is brought to pass through the first holding-down element 65, the second holding-down element 66 or the third holding-down element 67 and held orderly in the cable slot 81 by the holding-down element 65, 66 or 67. Since the first, the second and the third holding-down element 65, 66, 67 are provided for holding the set of cables 84 orderly in the cable slot 81, they can be of any configuration without being restricted to a specific form. FIGS. 6A to 6C illustrate the first, the second and the third holding-down element 65, 66, 67 in a form different from that shown in FIGS. 5A to 5C.

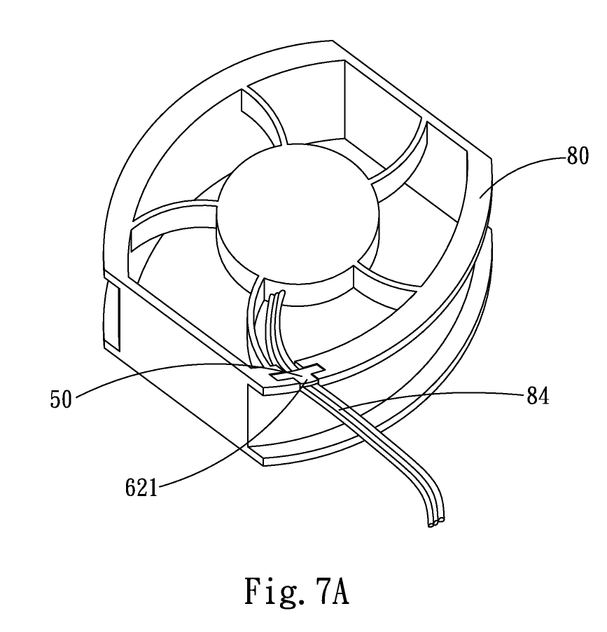

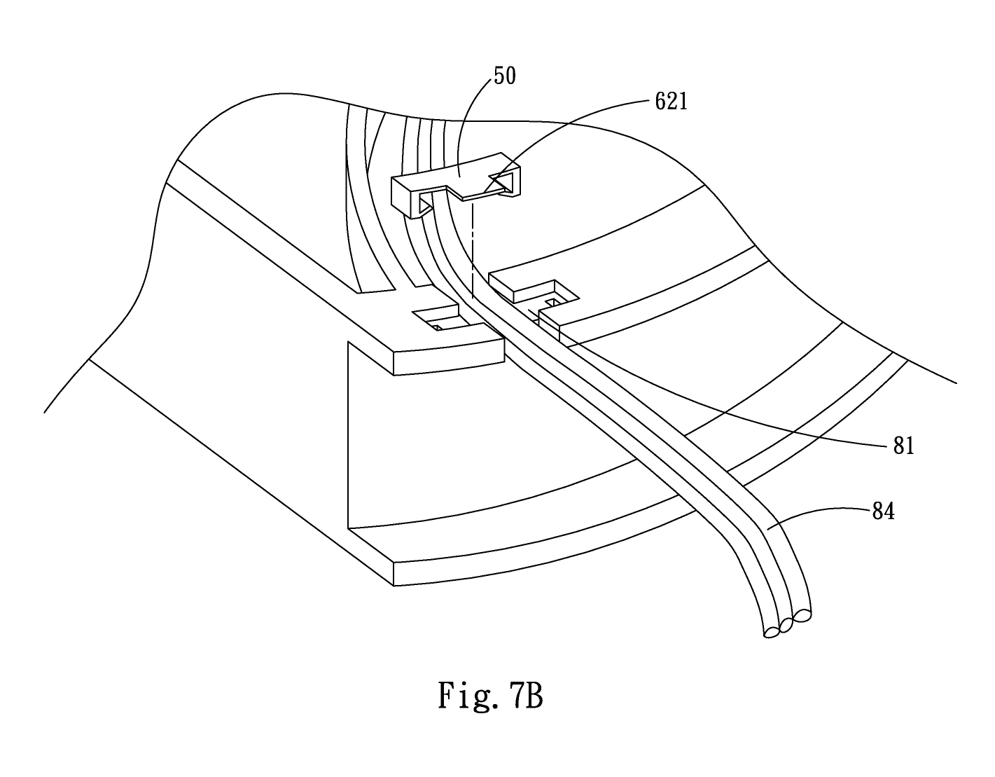

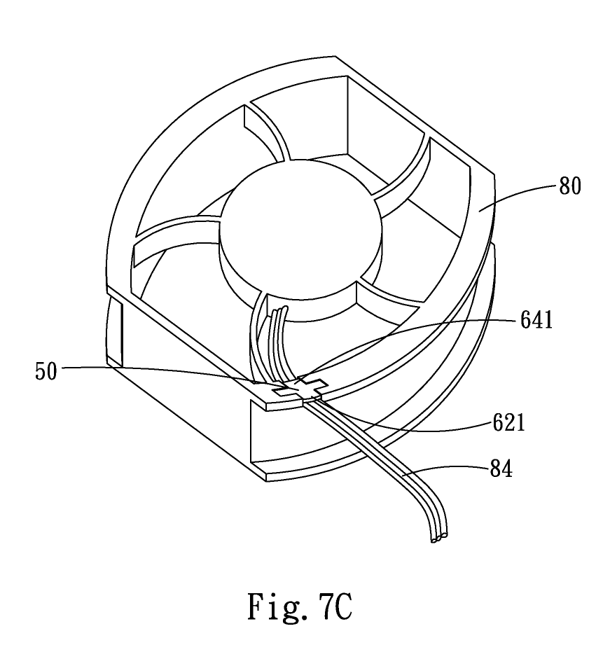

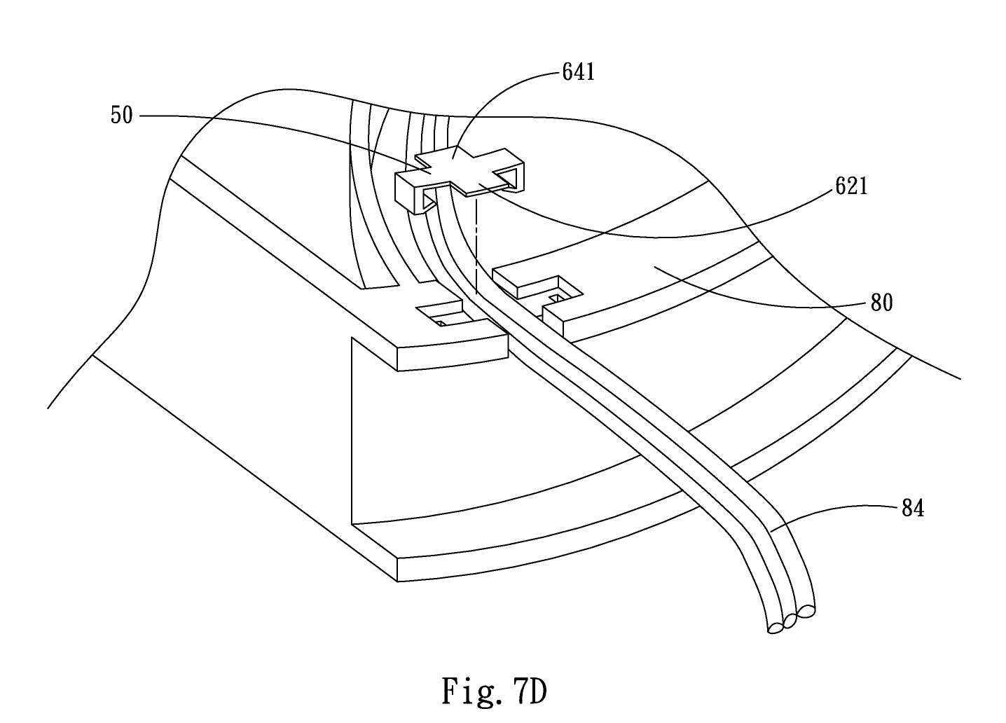

The frame 80 of the fan is not particularly restricted to the shape as shown in the first to the third embodiment of the present invention, but can also be, for example, a curved frame, as shown in FIGS. 7A to 7D. In this case, the cable retaining bracket 50 for assembling to the curved frame 80 can also be formed corresponding to the curvature of the frame 80, so as to be fitly locked to the cable slot 81 to hold the set of cables 84 orderly in the cable slot 81. Again, the first and the second shoulder portion 621, 641 can assist in holding down and guiding the set of cables 84 to the curved frame 80 and effectively prevent the set of cables 84 from becoming disorderly protruded beyond the frame 80.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A cable retaining bracket for assembling to a frame and thereby holding at least one cable against the frame, comprising: a main body having a first, a second, a third, and a fourth end; a first and a second retaining arm extended from the first and the third end, respectively; and a first shoulder portion extended from one of the second and the fourth end of the main body; wherein the first retaining arm and the second retaining arm are located opposite to each other.

2. The cable retaining bracket as claimed in claim 1, further comprising a second shoulder portion extended from the other one of the second and the fourth end of the main body.

3. The cable retaining bracket as claimed in claim 1, further comprising at least one first holding-down element provided on the main body at one side facing toward the frame for holding the at least one cable thereto.

4. The cable retaining bracket as claimed in claim 1, further comprising at least one second holding-down element provided on the first shoulder portion at one side facing toward the frame for holding the at least one cable thereto.

5. The cable retaining bracket as claimed in claim 2, further comprising at least one third holding-down element provided on the second shoulder portion at one side facing toward the frame for holding the at least one cable thereto.

6. The cable retaining bracket as claimed in claim 1, wherein the first shoulder portion is provided at an end corresponding to an outer side of the frame with at least one downward projected portion for guiding the at least one cable toward the frame.

7. A fan, comprising:
a frame being provided with a cable slot, a first receiving slot, and a second receiving slot; the cable slot being extended through the first and the second receiving slot for holding a set of cables therein; and the first and the second receiving slot being respectively internally provided with a first retaining hole and a second retaining hole; and
a cable retaining bracket including a main body having a first, a second, a third and a fourth end; a first and a second retaining arm respectively extended from the first and the third end of the main body; and a first shoulder portion extended from one of the second and the fourth end of the main body; wherein, the first and the second retaining arm are located opposite to each other and correspondingly inserted into the first and the second receiving slot, respectively.

8. The fan as claimed in claim 7, wherein the cable retaining bracket further includes a second shoulder portion extended from the other one of the second and the fourth end of the main body.

9. The fan as claimed in claim 7, wherein the cable slot on the frame has a first opening and a second opening.

10. The fan as claimed in claim 9, wherein the first shoulder portion is fitted in one of the first and the second opening.

11. The fan as claimed in claim 7, wherein the main body of the cable retaining bracket is provided at one side facing toward the frame with at least one first holding-down element for holding the set of cables against the cable slot.

12. The fan as claimed in claim 7, wherein the first shoulder portion of the cable retaining bracket is provided at one side facing toward the frame with at least one second holding-down element for holding the set of cables against the cable slot.

13. The fan as claimed in claim 8, wherein the second shoulder portion of the cable retaining bracket is provided at one side facing toward the frame with at least one third holding-down element for holding the set of cables against the cable slot.

14. The fan as claimed in claim 7, wherein the first and the second retaining arm are respectively extended through and stopped by the first and the second retaining hole from moving out of the first and the second receiving slot.

15. The fan as claimed in claim 7, wherein the first shoulder portion is provided at an end corresponding to an outer side of the frame with at least one downward projected portion for guiding the set of cables toward the frame.
